(19) United States
(12) Patent Application Publication
(10) Pub. No.: US 2015/0041464 A1
(43) Pub. Date: Feb. 12, 2015

(54) SYSTEM FOR STORAGE AND TRANSPORT

(71) Applicants: Benjamin Luke Van Der Linde, Heatherton (AU); David Leigh Scrimshaw, Heatherton (AU); Paul Francis Connor, Heatherton (AU); Paul Miller, Heatherton (AU); Ben Eyers, Heatherton (AU); Sion Netzler, Heatherton (AU); Lucas Lastman, Heatherton (AU)

(72) Inventors: Benjamin Luke Van Der Linde, Heatherton (AU); David Leigh Scrimshaw, Heatherton (AU); Paul Francis Connor, Heatherton (AU); Paul Miller, Heatherton (AU); Ben Eyers, Heatherton (AU); Sion Netzler, Heatherton (AU); Lucas Lastman, Heatherton (AU)

(73) Assignee: DEMAIN TECHNOLOGY PTY LTD, Heatherton, Victoria (AU)

(21) Appl. No.: 14/240,577

(22) PCT Filed: Aug. 25, 2011
(86) PCT No.: PCT/AU2011/001103

§ 371 Date: Oct. 17, 2014

(51) Int. Cl. B25H 3/02

(52) U.S. Cl. CPC B25H 3/023
USPC 220/23.88; 220/23.89

(57) ABSTRACT

The invention relates to a storage system for storing devices including: a frame for demountably supporting multiple carry cabinets, each carry cabinet being adapted to receive a device, characterised in that, said devices can be inserted or removed through a port in their respective carry cabinet while said multiple carry cabinets are mounted on the frame, and said devices can be transported in their respective carry cabinets when each of said carry cabinets are demounted from the frame.

### FIELD OF INVENTION

The present invention relates to a system for storage and transport of devices. In one form, the invention relates to a system for storage and transport of handheld power tools and accessories.

It will be convenient to hereinafter describe the invention in relation to power tools and their use by tradesmen and do-it-yourself (DIY) home handymen, however it should be appreciated that the present invention is not limited to that use only. The present invention has application to a wide range of devices, uses and users.

### BACKGROUND ART

It is to be appreciated that any discussion of documents, devices, acts or knowledge in this specification is included to explain the context of the present invention. Further, the discussion throughout this specification comes about due to the realisation of the inventor and/or the identification of certain related art problems by the inventor. Moreover, any discussion of material such as documents, devices, acts or knowledge in this specification is included to explain the context of the invention in terms of the inventor's knowledge and experience and, accordingly, any such discussion should not be taken as an admission that any of the material forms part of the prior art base or the common general knowledge in the relevant art in Australia, or elsewhere, on or before the priority date of the disclosure and claims herein.

Tradesmen and others who earn their living in the construction and building industry need to keep their tools in close proximity to their principal workplace. For example, those in a workshop or factory will typically keep their power tools stored adjacent their workshop or work bench. The storage means may range from haphazard organisation of boxes, to hanging the devices on a shadow board or placing them on steel shelving units or in a cupboard. Accessories are typically stored nearby, or in the case of small items such as drill bits, kept in storage drawers or trays. Storage is made more difficult by the variety of ways in which power tools are packaged for sale to consumers ranging from robust hinged cases to flimsy plastic bags intended for disposal.

Many tradesmen who carry out on-site work have to store their power tools in lockable boxes and cupboards in the rear of a vehicle such as a van or utility truck. In order to avoid the time and inconvenience of shifting tools between the vehicle and a principal workplace or worksite many tradesmen purchase two sets of tools.

Similarly, as the cost of power tools has diminished individuals in a domestic environment often possess a wide variety of power tools for DIY projects or hobbies. For example, individuals often own a range of handheld devices such as power drills, AC high speed drills, hammer drills, angle grinders, circular saw, jigsaws, sanders and so forth. They also typically own a range of accessories such as drill bits, sanding papers, sanding belts, cutting blades, battery packs, torches and other lighting, battery chargers, power extension leads and multipoint plugs. Individuals commonly have the power tools stored in a garage or shed, in a disorganised state, packaged or unpackaged, in cupboards or on shelves. This degree of disorganisation makes it particularly difficult for an individual if they need to find and pack up devices and relevant accessories and transport them any distance or use them at locations around their home.

### SUMMARY OF INVENTION

An object of the present invention is to provide a system for storage of devices in and area where they may be used, and transport to and from an area where they may be used.

Another object of the present invention is to provide a system for storage and transport of devices that is suitable for professionals and amateurs.

Another object of the present invention is to provide a system for storage and transport of devices and accessories that allows their ready interchange and rearrangement.

A further object of the present invention is to alleviate at least one disadvantage associated with the related art.

It is an object of the embodiments described herein to overcome or alleviate at least one of the above noted drawbacks of related art systems or to at least provide a useful alternative to related art systems.

In a first aspect of embodiments described herein there is provided a storage system for storing devices including:
a frame for demountably supporting multiple carry cabinets, each carry cabinet being adapted to receive a device, characterised in that,
said devices can be inserted or removed through a port in their respective carry cabinet while said multiple carry cabinets are mounted on the frame, and
said devices can be transported in their respective carry cabinets when each of said carry cabinets are demounted from the frame.

The frame to which the carry cabinets are mounted may be fixed free-standing, or mobile free-standing. Alternatively, the frame may be attached to a fixed structure such as a wall, or form part of a fixed structure.

Typically the carry cabinets of the storage system can be changed between a mounted and a demounted configuration respectively by engaging and disengaging a latch between the carry cabinet and frame. In a particularly preferred embodiment a simple form of latch is used, comprising one or more rails and correspondingly shaped slot(s). The rail may be integral with, or alternatively attached to the frame. The slot of the latch may be defined by a piece of metal or other material sharply curved to form a hook.

In one preferred option, the system includes two or more mountings for carry cabinets. This may be preferred for carry cabinets designed for particularly large or heavy devices. For example, the carry cabinet could include two or more hooks that can engage with two or more rails associated with the frame.

Preferably the mounting is lockable. For example the rail may include a cam that connects mounted carry cabinets such that when the cam is rotated, the carry cabinets are locked to the rail. This could be useful to prevent theft, and stop the carry cabinets accidentally demounting if for example, they were mounted to a frame in the rear of a van or truck.

### Carry Cabinet

In another aspect of embodiments described herein there is provided a carry cabinet suitable for use in the storage system of the present invention.

Typically each carry cabinet is of square or rectangular cross section so that multiple carry cabinets can be mounted side-by-side or one on top of the other. Typically the rear end of a rectangular or square carry cabinet includes at least one hook or other engagement means for engaging and disengaging the frame, thus mounting and demounting the carry cabinet on the frame.

Optimally, the positions of the mounted carry cabinets are interchangeable so that they may be arranged and re-arranged in any convenient order.

Typically each carry cabinet includes a fixed or detachable handle. The handle may for example, be used in a first, raised position for manual transportation and a second, retracted position when the carry cabinet is mounted on the frame. The handle may be moved between the first and second positions by rotation about pivots located at either end of the handle. This may make it easier to access the port, and/or the handle may act as a ‘spacer’ between adjacent carry cabinets. Optimally the handle can be rotated in one direction only so that all handles on mounted carry cabinets are identically oriented.

Preferably a releasable retainer holds the handle in the raised position. For example the retainer may comprise a detent to check the rotational motion of the handle. This will stop the handle falling into the second position which may be inconvenient for example, when the carry cabinet is being mounted on the frame. The retainer may be manually disabled with light manual pressure.

The port may be, for example, an opening, or open side in the carry cabinet. Preferably the carry cabinet includes a cover, such as a hinged door associated with the port. The cover may be adapted to be detached, or swung, rotated, slid, or otherwise moved to allow full access to the port. Typically the cover is transparent or translucent so that it is possible to identify the contents of the carry cabinet when the cover closes over the port.

In a particularly preferred embodiment the carry cabinets can be disassembled for flat packing. For example, if the carry cabinets are constructed of rectangular panels the side and end panels can be stacked for better freight and storage logistics and to take up minimal retail shelf space.

The interior of the carry cabinet may be configured in any convenient manner such as to receive and firmly hold a device, such as a power tool, or accessories for the device. It is important that the cabinet holds the device or accessories firmly when mounted, when being transported and during mounting/dismounting from the frame. The carry cabinet may, if convenient, be configured to receive an insert consisting of some or all of the packaging in which the device was sold. This would include packaging such as ‘cradles’ or ‘storage docks’. These could for example, be sold with power tools. The storage docks could be constructed of robust plastic material. In a particularly preferred embodiment the storage dock can be slidably inserted along slots in the carry cabinet, preferably using a handle. The handle may be adapted to act as a spacer for at least one other adjacent insert and may, for example prevent a storage dock being inserted in the wrong position.

Preferably the interior of the carry cabinet may be configured using inserts comprising removable dividers or drawers. For example the interior surface of the carry cabinet may be able to slidably receive one or more dividers at one or more positions for location or support of a drawer, or device, or accessory, with or without packaging. Thus a single design of carry cabinet can be adapted to house a wide range of sizes of devices and accessories, thus avoiding the need to design and manufacture multiple housings. Preferably the dividers will interlock with the interior surface of the carry cabinet to provide bracing and thus rigidity and strength.

A removable divider in the form of a flat plate located underneath a drawer may provide support, while a removable divider in the form of a flat plate located above a drawer may enclose the contents so that they do not fall out. The divider may also include a releasable latch for retaining the drawer. Typically the drawers can be slidably positioned in the carry cabinet and readily removed. Optimally they may be slid out at a downward angle so the contents can be easily seen and accessed. The drawers would typically be used for small accessories such as drill bits, cutting blades and batteries.

### Shelf

Preferably the storage system includes a shelf removably attached to the frame, or a wall or other structure adjacent the frame. The shelf or shelves may be located at any convenient positions on the frame. Typically the shelf would be elevated, located adjacent the lower surface of mounted carry cabinets.

The shelf may be adapted to support or be used in concert with the devices and accessories in the carry cabinets. For example the shelf may include electrical mountings or connections with wiring to the mains hidden within the frame. The shelf may also include drawers, recesses or other physical supports for devices or accessories.

The shelf may be connected to the frame for shipping and transport to avoid any warping in transit.

### Bench

Preferably the storage system includes a bench removably attached to the frame. The bench may be located at any convenient position on the frame.

Typically the bench would be located such that carry cabinets could be mounted above or optionally below the bench.

In a particularly preferred embodiment the storage system of the present invention is a bench, that is, the frame consists or comprises a bench that may be free standing, mobile free standing or attached to a structure such as a wall or floor.

### Cover

The storage system may include an openable cover or ‘hood’ which can move from a first, open position to a second, closed position. In the closed position the cover typically encloses the shelf and/or mounted carry cabinets and may be lockable.

It may be convenient to attach the cover to the frame, or a rail forming part of a latch for mounting and demounting the carry cabinets, or a wall or other structure adjacent the frame. Typically the cover is attached to the frame using a pivot or spring mechanism.

### Devices and Accessories

The devices contained in the carry cabinets are typically chosen from the group comprising drilling apparatus, cutting apparatus, grinding apparatus, impact drilling apparatus, screw driving apparatus and combinations thereof. For example the devices may include common AC or DC power tools such as power drills, high speed drills, hammer drills, angle grinders, circular saw, jigsaws, sanders and so forth.

The accessories are typically items used in conjunction with power tools or associated with the relevant type of work. For example, accessories would include drill bits, sanding papers, sanding belts, cutting blades and battery packs for use with the power tools. Accessories would also include torches and other lighting, battery chargers, power extension leads and multipoint plugs which contribute to carrying out the relevant work.

In a preferred embodiment, a carry cabinet can carry a device and a draw adapted to store accessories for the device. For example the interior of the draw may be configured to hold the accessories to keep them organised, make them easy to identify and stop them moving about when the carry cabinet is moved. In a particularly preferred embodiment accessories are sold separately from a drawer. Alternatively the accessories may be sold with a drawer functioning as packaging, enabling them to be fitted directly into a carry cabinet.

Some of the many accessories that can be used with the system of the present invention are power and light modules. These include work lights, spotlights, multi-power point strips optionally with retractable power cords. These are particularly valuable for those using power tools. It is particularly convenient to have these stored in carry cabinets, readily demountable to transport to a workplace indoor or outdoor. Alternatively they may be adapted for removable attachment to the frame, particularly the rail, or the shelf where they are held secure. Furthermore a multi-power point strip can be oriented horizontally for ease of use and connection when mounted on the frame or on the shelf and oriented vertically in the carry cabinet.

Another accessory that can be used with the system of the present invention is an audio/communications device. For example the audio/communications device may include functionality derived from mobile phone connection (eg iPhone dock, blutooth connectivity), audio connection (eg for mp3 players, CD player, iPods), AM/FM/digital radio and any other convenient audio or communications means. In a particularly preferred embodiment the audio/communications device includes a charging mat to charge audio or communications devices, particularly mobile phones or mp3 players.

Locating these devices within a carry cabinet creates a low cost, robust, transportable audio module for use at a worksite, particularly outdoor worksites. The audio/communications device may be plugged into an external power source such as the electricity mains or an electricity generator, or operated by battery, or any other convenient means. In a particularly preferred embodiment the audio/communications device can be powered by plugging into a controller for a drill head or other tool part.

Optimally any speaker internal or integral to the audio/communications device may be improved, for example, by conversion from mono to stereo by coupling to an external speaker/sub woofer/amp.

Other aspects and preferred forms are disclosed in the specification and/or defined in the appended claims, forming a part of the description of the invention.

In essence, embodiments of the present invention stem from the realization that cabinets can be adapted for storage and transport of devices and accessories that allows their ready interchange and rearrangement while maintaining the ability to readily access the devices and accessories.

Advantages provided by the present invention comprise the following:
ability to add to the fundamental system on an ‘as needs’ basis, buying only what is needed at any particular time;
the system can be used and afforded by professionals or amateurs;
allows devices to be readily put in order, identified, rearranged, stored and transported;
provides universal use/interchangeability of the carry cabinets allowing multiple uses and re-uses;
devices and accessories can be kept secure at any convenient locus such as a workshop or vehicle and transported therefrom.

Further scope of applicability of embodiments of the present invention will become apparent from the detailed description given hereinafter. However, it should be understood that the detailed description and specific examples, while indicating preferred embodiments of the invention, are given by way of illustration only, since various changes and modifications within the spirit and scope of the disclosure herein will become apparent to those skilled in the art from this detailed description.

### BRIEF DESCRIPTION OF THE DRAWINGS

Further disclosure, objects, advantages and aspects of preferred and other embodiments of the present application may be better understood by those skilled in the relevant art by reference to the following description of embodiments taken in conjunction with the accompanying drawings, which are given by way of illustration only, and thus are not limitative of the disclosure herein, and in which:

FIG. 1 illustrates a carry cabinet for use with the storage system of the present invention in (a) a perspective view when dismounted, and (b) in a perspective view while mounted with three other carry cabinets;

FIG. 2 illustrates a perspective view of single carry cabinet mounted on a frame according to the storage system of the present invention;

FIG. 3 illustrates a perspective view of the single carry cabinet and frame of FIG. 2 combined with a shelf;

FIG. 4 illustrates a perspective view of multiple carry cabinets mounted on the frame of FIG. 2;

FIG. 5 illustrates a perspective view of multiple carry cabinets mounted on the frame of FIG. 2 in combination with a shelf and cover; and

FIG. 6 illustrates a perspective view of the storage system as depicted in FIG. 5 with the cover in the closed position.

### DETAILED DESCRIPTION

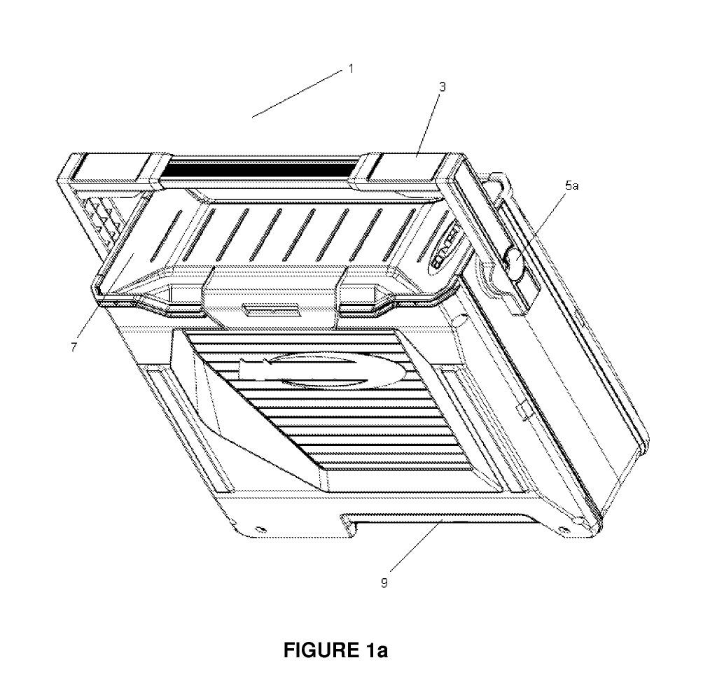

FIG. 1a depicts a carry cabinet 1 suitable for use in the storage system of the present invention. In this embodiment the carry cabinet is of rectangular cross section and includes a handle 3 rotatable about pivots 5a, 5b (5b not visible in this view) at either end of the handle 3. The handle is depicted in a first, raised position for manual transportation, held in that position by a detent (not visible in this view). The detent may be overcome with medium manual pressure and the handle 3 may rotated in one direction only about the pivots 5a, 5b to provide unfettered access the opaque cover 7 covering the port. The port substantially comprises an open side in the carry cabinet 1 and the cover 7 comprises a hinged door which in this view is shown to be closed over the port. When the cover 7 is open it permits full access to the interior of the carry cabinet 1 so that a device may be inserted or removed.

One end 9 of the carry cabinet 1 includes a hook or other engagement means for engaging and disengaging the frame as the carry cabinet is mounted and dismounted.

FIG. 1b depicts the carry cabinet 1 of FIG. 1a mounted on a frame 4 according to the storage system of the present invention. The handle 3 can be seen in the lowered position, having been rotated out of the raised position shown in FIG. 1a. Three other carry cabinets are also demountably supported on the frame 4. The rear surfaces of the carry cabinets include latches (not visible in this view) for engaging the frame 4. Two of the carry cabinets 1, 6 include hinged doors and can be used to store devices such as power tools. Carry cabinet 13 includes a removable multi-point power board, other power outlets and a work light. Carry cabinet 11 includes an audio/communications device including a speaker, AM/FM/digital radio and audio connection for an mp3 players or iPod.

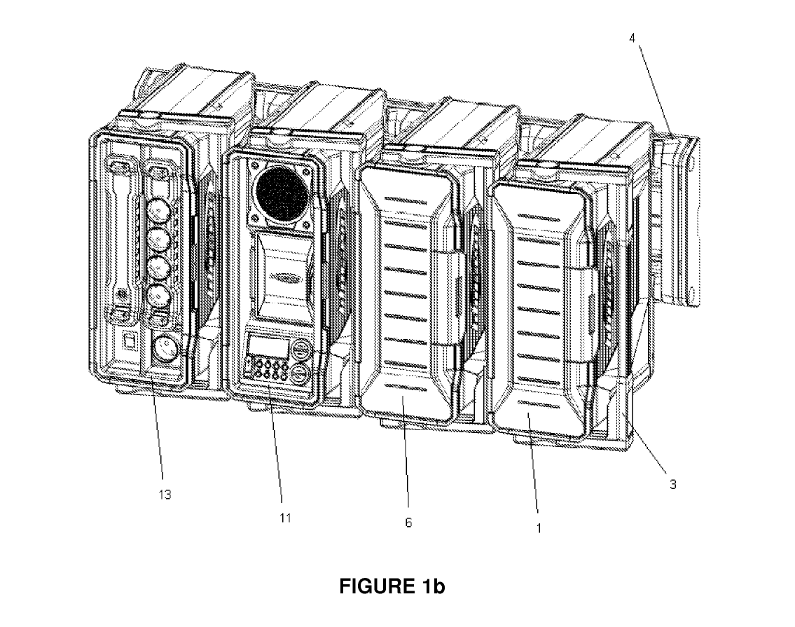

FIG. 2 depicts a further embodiment of a carry cabinet 2 mounted on a frame 10 according to the storage system of the present invention. The frame 10 can demountably support multiple carry cabinets however for clarity, only one is shown in this drawing. The rear surface of the carry cabinet 2 includes a hook-like formation 12 for engaging a corresponding shaped rail or ridge 14 on the frame 10. The carry cabinet 2 includes an opaque cover 8. Thus it is possible to identify any device inside the carry cabinet 2. Opening the opaque cover 8 provides access to the device.

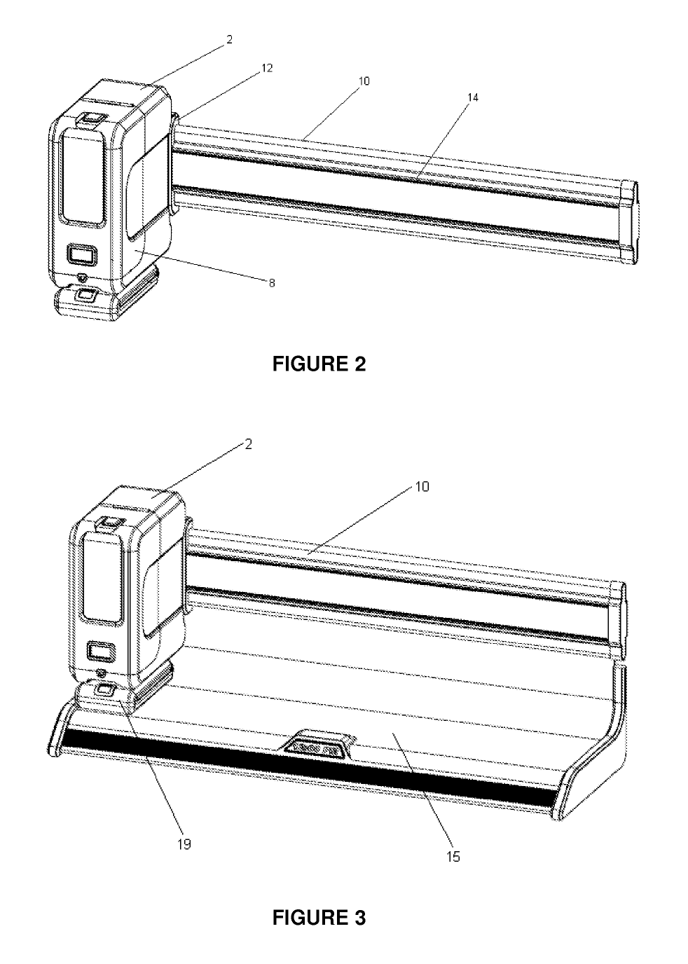

FIG. 3 depicts the carry cabinet 2 and frame 10 of FIG. 2 combined with a shelf 15 attached to the lower edge of the frame 10. The shelf 15 can be used to support useful items. In this embodiment the carry cabinet 2 is adapted to support a drawer 19 for storing accessories such as drill bits for use with the power drill 12.

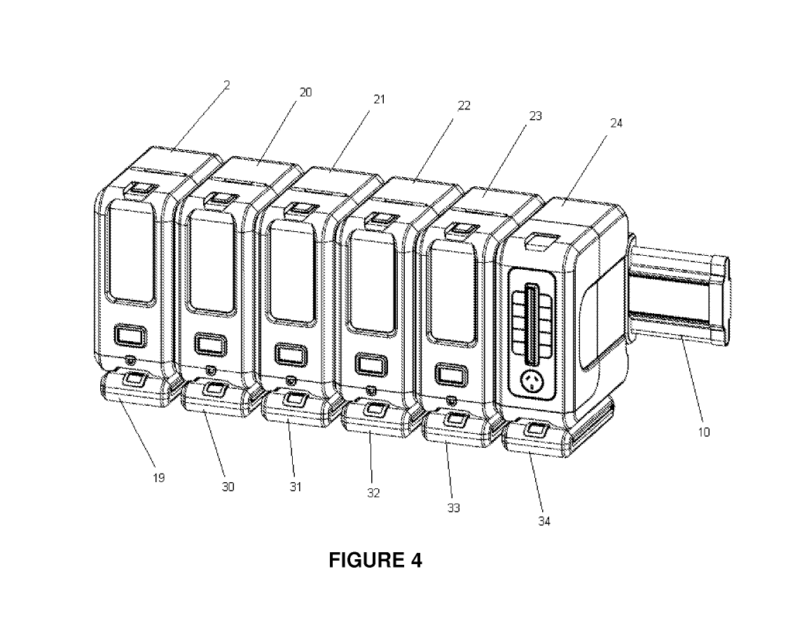

FIG. 4 illustrates multiple carry cabinets 2, 20-24 mounted on the frame 10 of FIG. 2. The cabinets may be readily re-arranged and put in a different order. In this arrangement it is easy for the user to find and collect the devices and accessories he needs and demount their carry cabinet. Alternatively the user can re-pack the device(s) and accessories in a single carry cabinet.

Each carry cabinet 2, 20-24 is adapted to support a drawer 19, 30-34 for storing accessories. Each carry cabinet 2, 20-23 stores one or more devices. Carry cabinet 24 stores a multi-point power board 42 including an extendible power cord (not visible).

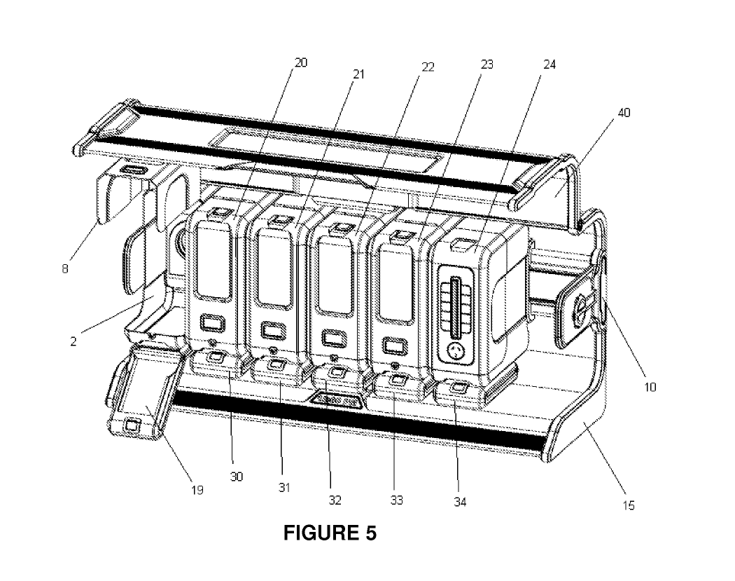

FIG. 5 illustrates multiple carry cabinets 2,20-24 mounted on the frame 10 of FIG. 2 in combination with a shelf 15, drawers 19,30-34 for storing accessories and a hood (cover) 40. The cover 40 is pivotally attached to either end of the frame 10 and in this view is shown in the open position. Also in this view, the cover 8 is lifted to show the interior of the carry case 2, and drawer 19 is extended to show how it has a downward slope to provide a user with an adequate view and adequate access to the contents.

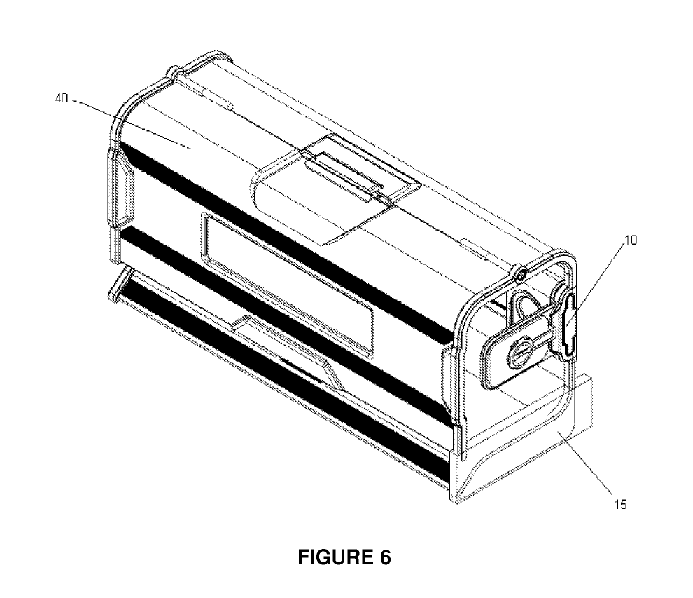

FIG. 6 illustrates the storage system as depicted in FIG. 5, with the cover 40 in the closed position, enclosing the mounted carry cabinets 2, 20-24. The cover 40 can be locked to the frame 10 and/or shelf 15 to keep the carry cabinets secure.

While this invention has been described in connection with specific embodiments thereof, it will be understood that it is capable of further modification(s). This application is intended to cover any variations uses or adaptations of the invention following in general, the principles of the invention and including such departures from the present disclosure as come within known or customary practice within the art to which the invention pertains and as may be applied to the essential features hereinbefore set forth.

As the present invention may be embodied in several forms without departing from the spirit of the essential characteristics of the invention, it should be understood that the above described embodiments are not to limit the present invention unless otherwise specified, but rather should be construed broadly within the spirit and scope of the invention as defined in the appended claims. The described embodiments are to be considered in all respects as illustrative only and not restrictive.

Various modifications and equivalent arrangements are intended to be included within the spirit and scope of the invention and appended claims. Therefore, the specific embodiments are to be understood to be illustrative of the many ways in which the principles of the present invention may be practiced. In the following claims, means-plus-function clauses are intended to cover structures as performing the defined function and not only structural equivalents, but also equivalent structures.

“Comprises/comprising” and “includes/including” when used in this specification is taken to specify the presence of stated features, integers, steps or components but does not preclude the presence or addition of one or more other features, integers, steps, components or groups thereof. Thus, unless the context clearly requires otherwise, throughout the description and the claims, the words ‘comprise’, ‘comprising’, ‘includes’, ‘including’ and the like are to be construed in an inclusive sense as opposed to an exclusive or exhaustive sense; that is to say, in the sense of “including, but not limited to”.

1. A storage system for storing devices including:
a frame for demountably supporting multiple carry cabinets, each carry cabinet being adapted to receive a device,
characterised in that,
said devices can be inserted or removed through a port in their respective carry cabinet while said multiple carry cabinets are mounted on the frame, and
said devices can be transported in their respective carry cabinets when each of said carry cabinets are demounted from the frame.

2. A storage system according to claim 1 wherein the devices are chosen from the group comprising electric tools, battery powered tools, electronic devices, electrical devices and combinations thereof.

3. A storage system according to claim 2 wherein the devices are chosen from the group comprising drilling apparatus, cutting apparatus, grinding apparatus, impact drilling apparatus, screw driving apparatus and combinations thereof.

4. A storage system according to claim 1 wherein a carry cabinet can be changed between a mounted and a demounted configuration respectively by engaging and disengaging a latch between the carry cabinet and frame.

5. A storage system according to claim 4 wherein the latch comprises a rail and correspondingly shaped slot.

6. A storage system according to claim 5 wherein the frame includes multiple rails, each interlocked to an adjacent rail.

7. (canceled)

8. A storage system according to claim 1 wherein each carry cabinet includes a handle which can be used in a first, raised position for manual transportation and a second, retracted position when the carry cabinet is mounted on the frame.

9. (canceled)

10. A storage system according to claim 1 wherein the frame may be used for demountably supporting one or more of said devices.

11. A storage system according to claim 10 wherein the device supported by the frame is chosen from the group comprising a power module, a multi-point power outlet having a retractable cord, a light module, an audio device, a communications device, charging mat for an electronic device or combinations thereof.

12. (canceled)

13. (canceled)

14. A storage system according to claim 1 which comprises a bench.

15. (canceled)

16. A storage system according to claim 1 which comprises a panel which is suitable for use as a shelf, the panel being horizontally mounted on the frame adjacent said carry cabinets and suitable for demountably supporting one or more of said devices.

17. A storage system according to claim 16 wherein the device supported by the panel is chosen from the group comprising a power module, a multi-point power outlet having a retractable cord, a light module, an audio module, a communications interface, charging mat for an electronic device or combinations thereof.

18. A storage system according to claim 17 wherein the panel is demountable from the frame.

19. A storage system according to claim 1 which comprises an openable cover for enclosing said mounted carry cabinets.

20. A storage system according to claim 5 which comprises an openable cover which is mounted to the frame.

21. A storage system according to claim 1 wherein the frame comprises a base member for location at floor level, which supports members on which the carry cabinets may be mounted, and wherein the frame is either fixed, freestanding, or mobile freestanding.

22. A carry cabinet suitable for use with the storage system of claim 1 wherein each carry cabinet is further adapted to receive at least one insert chosen from the group comprising drawers, dividers, shelves, storage docks and combinations thereof.

23. A storage dock suitable for being received in the carry cabinet of claim 22, the storage dock including a handle adapted to act as a spacer for at least one other adjacent insert.

24. A carry cabinet according to claim 22 wherein the insert is slidably received in a carry cabinet and adapted to releasably receive device accessories by interference fit.

25. A carry cabinet according to claim 22, each carry cabinet including a port for insertion or removal of the device, wherein the carry cabinet includes a cover associated with the port.
